(19) United States
(12) Patent Application Publication
(10) Pub. No.: US 2007/0005195 A1
(43) Pub. Date: Jan. 4, 2007

(54) Distributed energy storage for reducing power demand

(76) Inventors: Nicholas Pasquale, Somers, NY (US); Ib Ingemann Olsen, New York, NY (US)

Correspondence Address: FISH & RICHARDSON P.C., P.O. BOX 1022, MINNEAPOLIS, MN, 55440-1022, US

(21) Appl. No.: 11/328,460

(22) Filed: Jan. 10, 2006

Related U.S. Application Data
(60) Provisional application No. 60/642,851, filed on Jan. 10, 2005.

(51) Int. Cl. H02J 3/00

(52) U.S. Cl. 700/295; 700/291

(57) ABSTRACT

Mating an energy storage component and a power conversion and delivery component with computer intelligence and digital data communications hardware helps to effectively and efficiently monitor and react to the power demand profile at a location in an advanced manner without expensive industrial controls or human interaction. A local power source includes an energy storage component and a power conversion and delivery component, and delivers power to a load or a load group. The local power source is controlled by a control component including, for example, digital computer hardware and digital communications hardware. The control component is capable of monitoring power demand, detecting various stimuli, and triggering a reaction by the local power source to reduce peak demand.

### CROSS-REFERENCE TO RELATED APPLICATION

The present application claims priority from U.S. provisional application No. 60/642,851 filed Jan. 10, 2005, and titled “Electrical power peak demand reduction system with dynamic control,” which is incorporated herein by reference in its entirety for all purposes.

### TECHNICAL FIELD

This application relates to electrical power storage and distribution.

### BACKGROUND

A utility distributes power (e.g., electricity or energy) to loads connected to an electrical transmission system (e.g., grid or distribution network). Loads connected to the utility's network do not always demand (e.g., consume) power at a constant rate. In some instances, the utility may experience periods of peak power demand that are greater than the average power demand. In order to satisfy the power demand during periods of peak demand, the utility may operate at or near to maximum capacity, it may operate supplemental generators, and/or it may purchase electricity from other sources. When the electrical transmission system runs near capacity, there is a potential that the system may fail, and operating supplemental generators and purchasing electricity from other sources may increase the utility's operating costs and may have a significant negative environmental impact. As a result, the utility may charge a consumer a premium for peak electricity demand. For example, the premium may take the form of higher average rates and/or additional charges based on the consumer's peak demand.

### SUMMARY

According to one general aspect, a system is configured for operation at a residential location. The residential location has at least one load that exhibits a demand characteristic that changes in excess of a threshold level, at least one load that has a demand characteristic that changes less than the threshold level, and an electrical distribution panel. The electrical distribution panel is configured to receive power at the residential location from a remote power source, to distribute a portion of the received power to the at least one load that has a demand characteristic that changes in excess of the threshold level, and to distribute another portion of the received power to the at least one load that has a demand characteristic that changes less than the threshold level. The system includes a local power source. The local power source is configured to connect to the electrical distribution panel, and to connect, in series, to the at least one load that has a demand characteristic that changes less than the threshold level. The local power source is further configured to access an indication of a power demand generated by loads at the residential location, and to determine, based on the accessed indication of power demand generated by loads at the residential location, that a peak power demand is occurring at the residential location. Based on the determination that the peak power demand is occurring at the residential location, the system provides power to the at least one load that has a demand characteristic that changes less than the threshold level.

Implementations of the above general aspect may include one or more of the following features. For example, the local power source may include a component for storing energy, a component for converting the stored energy and providing power, and a processing device. The processing device may be configured to access the indication of the power demand generated by loads at the residential location, determine, based on the accessed indication of power demand generated by loads at the residential location, that the peak power demand is occurring at the residential location, and inspire the component for converting the stored energy and providing power to provide power to the at least one load that has a demand characteristic that changes less than the threshold level, based on the determination that the peak power demand is occurring at the residential location.

The system may include a location demand sensing device configured to sense the power demand at the residential location, and provide the indication of the power demand at the residential location. The location demand sensing device may be located at the electrical distribution panel. The received power may include a received current, and the location demand sensing device may include a current clamp that senses the received current.

The system may include an input power sensing device configured to sense a power input to the local power source, and provide an indication of the power input to the local power source. The processing device may be configured to access the indication of the power input to the local power source, and regulate the power provided by the component for converting the stored energy and providing power to the at least one load that has a demand characteristic that changes less than the threshold level. The power input to the local power source may include an input current, and the input power sensing device may include a current clamp that senses the input current.

The local power source may determine that the peak power demand is occurring at the residential location, and the determination that the peak power demand is occurring at the residential location may be based, at least in part, on the indication of the power demand at the residential location. The local power source may be configured to access one or more operational parameters, and the determination that the peak power demand is occurring at the residential location may be based on the one or more operational parameters in addition to the indication of the power demand at the residential location. The one or more operational parameters may include historical power and energy consumption data, environmental data, utility response data, utility crisis situation dispatch data, look-up tables based on analytical data relating to peak demand issues, local power source energy storage level data, local power source operational health data, time of day data, seasonal timing data, load profile data from main electrical service entries, and load profile data of individual loads.

The local power source may be configured to provide power supplemental to and concurrently with the portion of the received power distributed to the at least one load that has a demand characteristic that changes less than the threshold level.

According to another general aspect, an indication of a power demand generated by loads at a residential location is accessed. The residential location has at least one load that has a demand characteristic that changes in excess of a threshold level, at least one load that has a demand characteristic that changes less than the threshold level, and an electrical distribution panel. The electrical distribution panel is configured to receive power at the residential location from a remote source, distribute a portion of the received power to the at least one load that has a demand characteristic that changes in excess of the threshold level, and to distribute a portion of the received power to the at least one load that has a demand characteristic that changes less than the threshold level. Based on the accessed indication of power demand generated by loads at the residential location, it is determined that a peak power demand is occurring at the residential location. Based on the determination that the peak power demand is occurring at the residential location, power is provided to the at least one load that has a demand characteristic that changes less than the threshold level.

Implementations of the above general aspect may include one or more of the following features. For example, the received power may include a received current, and accessing an indication of the power demand at the residential location may include sensing the received current at the electrical distribution panel.

A power input to the local power source may be sensed, and providing power to the at least one load that has a demand characteristic that changes less than the threshold level may include controlling the power provided based on the sensed power input to the local power source.

The determination that the peak power demand is occurring at the residential location may be based, at least in part, on the indication of the power demand at the residential location. One or more operational parameters may be accessed, and the determination that the peak power demand is occurring at the residential location may be based on the one or more operational parameters in addition to the indication of the power demand at the residential location. The one or more operational parameters may include historical power and energy consumption data, environmental data, utility response data, utility crisis situation dispatch data, look-up tables based on analytical data relating to peak demand issues, local power source energy storage level data, local power source operational health data, time of day data, seasonal timing data, load profile data from main electrical service entries, and load profile data of individual loads.

Determining that a peak power demand is occurring may include determining an amount by which the power demand at the residential location exceeds a desired level, and providing power to the at least one load that has a demand characteristic that changes less than the threshold level may include providing no more power than the amount by which the power demand at the residential location exceeds the desired level.

Providing power to the at least one load that has a demand characteristic that changes less than the threshold level may include providing power supplemental to and concurrently with the portion of the received power distributed to the at least one load that has a demand characteristic that changes less than the threshold level.

According to another general aspect, a system is configured for operation at a location. The location has an electrical distribution panel, one or more loads, and a local power network connected to the electrical distribution panel and the one or more loads. The electrical distribution panel is configured to receive power at the location from a remote power source and distribute the received power to the one or more loads over the local power network. The system includes a local power source, at the location. The local power source is configured to connect to the electrical distribution panel in parallel with the remote power source. The system is also configured to access an indication of a power demand generated by loads at the location, and determine, based on the accessed indication of power demand generated by loads at the location, that a peak power demand is occurring at the location. Based on the determination that the peak power demand is occurring at the location, the local power source injects supplemental power through the electrical distribution panel into the local power network, such that the supplemental power and the received power are distributed to the one or more loads concurrently.

Implementations of the above general aspect may include one or more of the following features. For example, the local power source may be configured to limit the supplemental power injected into the local power network such that the supplemental power may be less than the indication of the power demand at the location.

The local power source may include a component for storing energy, a component for converting the stored energy and providing power, and a processing device. The processing device may be configured to access the indication of the power demand at the location, determine, based on the accessed indication of power demand at the location, that the peak power demand is occurring at the location, and inspire the component for converting the stored energy and providing power to inject supplemental power through the electrical distribution panel into the local power network, based on the determination that the peak power demand is occurring at the location.

The system may include a location demand sensing device configured to sense the power demand at the location, and provide the indication of the power demand at the location. The location demand sensing device may be located at the electrical distribution panel. The received power may include a received current, and the location demand sensing device may include a current clamp that senses the received current.

The system may include an output power sensing device configured to sense a power output by the local power source, and provide an indication of the power output by the local power source. The processing device may be configured to access the indication of the power output by the local power source and regulate the power injected into the local power network by the component for converting the stored energy and providing power. The power output by the local power source may include an output current, and the output power sensing device may include a current clamp that senses the output current.

The local power source may determine that the peak power demand is occurring at the location, and the determination that the peak power demand is occurring at the location may be based, at least in part, on the indication of the power demand at the location. The local power source may be configured to access one or more operational parameters, and the determination that the peak power demand is occurring at the location may be based on the one or more operational parameters in addition to the indication of the power demand at the location. The one or more operational parameters may include historical power and energy consumption data, environmental data, utility response data, utility crisis situation dispatch data, look-up tables based on analytical data relating to peak demand issues, local power source energy storage level data, local power source operational health data, time of day data, seasonal timing data, load profile data from main electrical service entries, and load profile data of individual loads.

According to another general aspect, an indication of a power demand at a location is accessed. The location includes an electrical distribution panel, one or more loads, and a local power network connected to the electrical distribution panel and the one or more loads. The electrical distribution panel is configured to receive power at the location from a remote power source and distribute the received power to the one or more loads over the local power network. Based on the accessed indication of power demand at the location, it is determined that a peak power demand is occurring at the location. Based on the determination that the peak power demand is occurring at the location, supplemental power is injected through the electrical distribution panel into the local power network, such that the supplemental power and the received power are distributed to the one or more loads concurrently.

Implementations of the above general aspect may include one or more of the following features. For example, the received power may include a received current, and accessing an indication of the power demand at the location may include sensing the received current at the electrical distribution panel.

A power output by the local power source may be sensed and injecting power into the local power network may include controlling the power injected based on the sensed power output by the local power source.

The determination that the peak power demand is occurring at the location may be based, at least in part, on the indication of the power demand at the location. One or more operational parameters may be accessed, and the determination that the peak power demand is occurring at the location may be based on the one or more operational parameters in addition to the indication of the power demand at the location. The one or more operational parameters may include historical power and energy consumption data, environmental data, utility response data, utility crisis situation dispatch data, look-up tables based on analytical data relating to peak demand issues, local power source energy storage level data, local power source operational health data, time of day data, seasonal timing data, load profile data from main electrical service entries, and load profile data of individual loads.

According to another general aspect, an indication of a power demand at a residential location is accessed and one or more operational parameters are accessed. Based on the accessed indication of the power demand at the residential location and the accessed one or more operational parameters, it is determined that a peak power demand is occurring at the residential location.

Implementations of the above general aspect may include one or more of the following features. For example, the one or more operational parameters include historical power and energy consumption data, environmental data, utility response data, utility crisis situation dispatch data, look-up tables based on analytical data relating to peak demand issues, local power source energy storage level data, local power source operational health data, time of day data, seasonal timing data, load profile data from main electrical service entries, and load profile data of individual loads.

The various aspects, implementations, and features may be implemented using, for example, one or more of a method, an apparatus, an apparatus or tool or processing device for performing a method, a program or other set of instructions, an apparatus that includes a program or a set of instructions, and a computer readable medium. The computer readable medium may include, for example, instructions, software, and other data.

The details of one or more implementations are set forth in the accompanying drawings and the description below. Other features, objects, and advantages will be apparent from the description and drawings, and from the claims.

### DESCRIPTION OF DRAWINGS

FIGS. 1 and 3 are block diagrams of one configuration that uses a local power source to provide supplemental power to loads at a location.

FIG. 2 is a flow chart illustrating an exemplary process for detecting a peak power demand and for using a local power source to provide power to reduce the peak power demand.

FIGS. 4a-4c are diagrams of another exemplary process for using a local power source to provide supplemental power during a peak power demand.

FIGS. 5 and 7 are block diagrams of another configuration that uses a local power source to provide supplemental power to loads at a location.

FIG. 6 is a flow chart illustrating another exemplary process for detecting a peak power demand and for using a local power source to provide power to reduce the peak power demand.

FIGS. 8a-8c are diagrams of another exemplary process for using a local power source to provide supplemental power during a peak power demand.

Like reference symbols in the various drawings indicate like elements.

### DETAILED DESCRIPTION

Distributed energy storage devices may be able to level or reduce peak power demand thereby benefiting either or both of consumers and utilities. If configured to benefit consumers, a consumer may be able to use an energy storage device to reduce his or her peak power demand thereby reducing his or her utility bill.

Alternatively or in addition, the deployment of distributed energy storage devices may be configured to benefit utilities, especially if a network of distributed energy storage devices are deployed. A network of distributed energy devices may allow the utility to provide power more efficiently and inexpensively. Moreover, the use of distributed energy storage devices may reduce the load carried by the electrical transmission system. This may decrease the probability of transmission system failure during peak demand and it also may prolong the life of the transmission system.

By mating an energy storage component and a power conversion and delivery component with computer intelligence and digital data communications hardware, it may be possible to effectively and efficiently monitor and react to the power demand profile at a location in an advanced manner without expensive industrial controls or human interaction.

For example, consider a typical homeowner who uses a heat pump to heat his home and who has his interior lights turned on and his refrigerator and hot water heater running. When the heat pump kicks into emergency heat mode, it may cause the homeowner's aggregated demand to increase by, for instance, 40%, instantaneously. Using technology described by this application, the increased demand is detected and a local power source is used to supplement the power provided by the utility company.

Configured in accordance with one implementation, the peak demand observed by the utility is thereby decreased, whether observed as a peak or over a moving average over time. The power from the local power source may be applied to the home and/or it's power consuming devices generally, or it may be applied to some selective subset of such devices (e.g., continuously operated devices such as the lights, devices that have a demand characteristic that changes less than a threshold level).

Additionally or alternatively, a sensing device located at the home's electrical distribution panel may sense the power demanded by the home from the utility and communicate the sensed power demand to the local power source, thereby allowing the local power source to detect a period of increased demand. Additional sensing devices may be used to monitor and regulate the power provided by the local power source to efficiently utilize the energy stored by the local power source.

Moreover, a local power source includes an energy storage component (e.g., a battery, a capacitor, a flywheel, a fuel cell, or a combustible fuel) and a power conversion and delivery component (e.g., power conversion and delivery hardware), and delivers power to a load or a load group. The local power source is controlled by a control component including, for example, digital computer hardware and digital communications hardware. The control component is capable of monitoring power demand, detecting various stimuli, and triggering a reaction by the local power source to reduce peak demand.

Real-time, or virtually real-time, power and energy measurements may be digitally acquired and stored. Historical data, environmental data and utility command data also can be acquired and used in conjunction with the real-time power and energy measurements to methodically address peak power demand reduction. The consideration of these factors may allow the local power source to make the best use of its stored energy in the process.

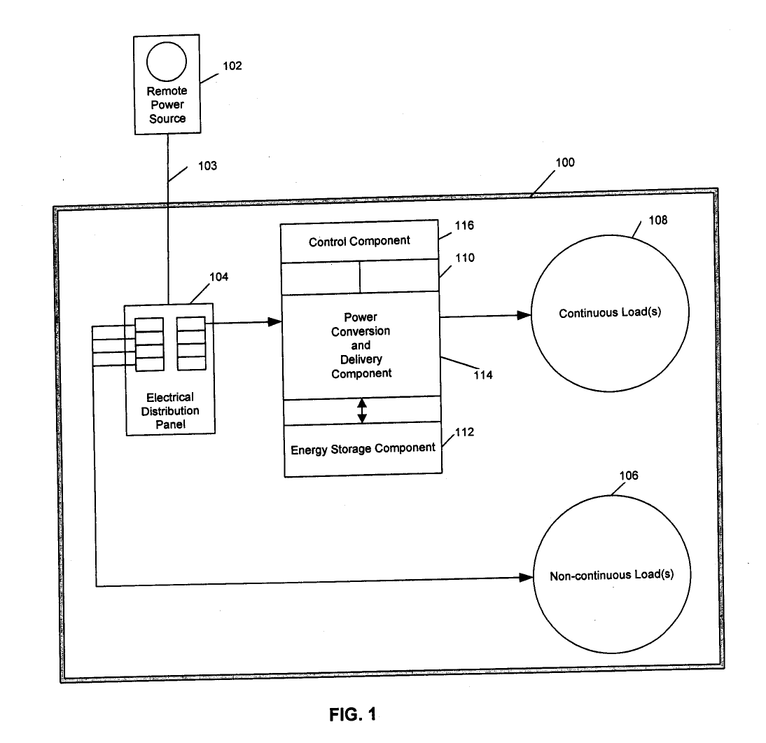

Referring to FIG. 1, a residential location 100 is connected to a remote power source 102 (e.g., utility) by an electrical transmission system 103 (e.g., power grid). The residential location 100 demands power from the remote power source 102 (e.g., utility) and the remote power source 102 delivers power to the residential location 100 to satisfy the demand. The location 100 does not always demand power at a constant rate. In some instances, the power demanded by the location 100 exceeds the average power demanded by the location 100. Such instances may be referred to as periods of peak demand. The operator (e.g., utility company) of the remote power source 102 may charge the party responsible for power at the location 100 (e.g., homeowner or business owner) a premium based on the location's 100 peak demand. For this, or for alternative or additional reasons, it may be desirable for the owner to limit or reduce periods or levels of peak demand at the location 100. Reducing or limiting periods or levels of peak demand may be referred to as peak reduction throughout this application.

The power delivered by the remote power source 102 to the location 100 is received by an electrical distribution panel 104 (e.g., utility service entry or source entry). The power delivered to location 100 by the remote power source 102 may be direct current (DC) or alternating current (AC). If the power delivered to the location 100 by the remote power source 102 is AC, the delivered power may include one or more phases. For example, the delivered power may be single-phase, two-phase, or three-phase power.

Loads 106 and 108 are connected to the electrical distribution panel 104. The connections between the loads 106 and 108 and the electrical distribution panel 104 may be direct or indirect. For example, loads 106 and 108 may be hardwired to the electrical distribution panel 104 individually, as shown, for example, by the multiple individual connections shown between loads 106 and electrical distribution panel 104. Additionally or alternatively, loads 106 and 108 may be connected, directly or indirectly, to the electrical distribution panel 104 in parallel or series with one or more additional loads (not shown).

Loads connected to the electrical distribution panel 104 may require single-phase, two-phase, or three-phase power. If a load requires single-phase power, the load will be connected to one phase at the electrical distribution panel 104. Similarly, if a load requires two-phase power, the load will be connected to two phases at the electrical distribution panel 104 and, if a load requires three-phase power, the load will be connected to three phases at the electrical distribution panel 104.

The electrical distribution panel 104 receives power from the remote power source 102 and distributes the received power to the loads 106 and 108.

Load 106 represents one or more non-continuous loads. In one exemplary scenario, a non-continuous load is a load that has a demand characteristic that changes in excess of a threshold level. In other words, the demand characteristic of such a non-continuous load generally is not constant over time. Rather, the demand profile of a non-continuous load generally exhibits peaks. Such peaks may be attributable to the fact that the non-continuous load is used only occasionally (e.g., the demand profile exhibits peaks as a consequence of turning the load on and off). Alternatively, such peaks may be attributable to the difference in power demanded by the load during ordinary operation as compared to the power demanded by the load during certain exceptional scenarios (e.g., a heat pump running in emergency heat mode). Non-continuous loads may include, for example, appliances with motors (e.g., espresso machines), heating, ventilation and air conditioning (HVAC) units, pumps, stoves, microwaves, dishwashers, washing machines, clothes dryers, freezers, electric water heaters, hair dryers, entertainment centers, garage door openers, gate openers, hot tubs, pool heaters, walk-in refrigerators, and workshop equipment such as, for example, routers, drills, and band saws. Non-continuous loads may not be critical appliances or devices and people may not rely upon non-continuous loads on an everyday basis. Due to the fact that the demand profiles for non-continuous loads generally are not constant over time, non-continuous loads often are responsible for causing dramatic or substantial changes in demand at the location 100. Such dramatic or substantial changes often coincide with or inspire peak demand characteristics. Thus, for example, turning on and using an espresso machine, a heater, or an air conditioning unit at the location 100 often may cause a peak in the power demanded by the location 100.

Load 108 represents one or more continuous loads. In one exemplary scenario, a continuous load is a load that has a demand characteristic that changes less than a threshold level. In other words, the demand characteristic of such a continuous load is relatively constant over time. Continuous loads may include, for example, lighting, security systems/devices, office machines (e.g., computers, printers, copiers, fax machines, etc.) and other electronic devices, de-humidifiers, ceiling fans, and attic exhaust fans. Continuous loads may be critical appliances or devices that people utilize or rely upon on an everyday basis. Due to the fact that the demand profiles for continuous loads are relatively constant over time, continuous loads generally are not responsible for dramatic changes in demand at the location 100, and thus, their operation characteristics do not tend to coincide with or inspire peak demand characteristics. For example, turning on a light or turning on and using a computer typically will not cause a peak in the power demanded by the location 100.

For purposes of the description provided of the implementation shown by FIG. 1, continuous loads 108 are connected to the electrical distribution panel 104 in series with local power source 110. Local power source 110 includes an energy storage component 112, a power conversion and delivery component 1 14, and a control component 116. The energy storage component 112 stores energy and may be, for example, a battery, a capacitor, a flywheel, a fuel cell, or a combustible fuel. The power conversion and delivery component 114 includes power conversion and delivery hardware and is configured to (1) convert the energy stored in the energy storage component 112 into power that can be provided to a load or load group and (2) deliver the converted energy to the load or load group. The power conversion and delivery hardware may include, for example, DC-AC inverters, or generators. The control component 116 controls the conversion and delivery of stored power and is configured to monitor power demand, detect various stimuli, and trigger reactions by the local power source 110 to reduce peak demand at the location 100. The control component 116 may include, for example, digital computer hardware and digital communications hardware. Local power source 110 may operate alternately as a pass-through or as a source of power for continuous loads 108.

When a peak demand occurs at the location 100, local power source 110 provides power to continuous loads 108.

The power provided to continuous loads 108 by local power source 110 during a peak demand may be supplemental power. That is, during a peak demand, the power provided to continuous loads 108 may include power received from the remote power source 102 as well as power provided by the local power source 110. For example, when the power demand at the location 100 exceeds a threshold level, the local power source 110 may provide a quantum of power to continuous load 108 that is equal to or substantially equal to the amount by which the power demand at the location 100 exceeds the threshold level. As a result, the net power demanded by the location 100—and thus, the net power delivered by the remote power source 102—is reduced by the quantum of power provided by the local power source 110 to the continuous loads 108.

Alternatively, the local power source 100 may provide 100% of the power consumed by continuous loads 108 during a peak demand. For instance, during periods of time when limited or no power is delivered to the location 100 by the remote power source 102 (e.g., a power outage, a brownout, or a blackout), the local power source 110 can be used to provide all of the power to continuous loads 108.

In contrast, during a peak demand at the location 100, local power source 110 does not provide power to non-continuous loads 106. Rather, during a period of peak demand, non-continuous loads 106 are powered solely by power received from the remote power source 102, and during periods where little or no power is delivered to the location 100 by the remote power source 102, the non-continuous loads 106 receive little or no power correspondingly.

It may seem counter-intuitive to use the local power source 110 to provide power to continuous loads 108 during a period of peak power demand when, more often than not, non-continuous loads 106 may be responsible for causing the peak in demand. Nevertheless, configuring the location 100 such that local power source 110 is in series with and provides power to continuous loads 108 may be particularly useful, whether or not configured to achieve one or more of the following features. For example, it may be possible to configure the location 100 to use the local power source 110 to provide power to continuous loads 108 and to reduce peak power demand in response to an increase in power demand from any load, or load set, connected to the electrical distribution panel 104.

In addition, the configuration illustrated in FIG. 1 preserves the ability to shed loads when, for example, the utility enters a crisis situation. In other words, the control component 116 can instruct the power conversion and delivery component 116 to discontinue providing power to a subset of the continuous loads 108 if necessary. Furthermore, the configuration illustrated in FIG. 1 facilitates load matching, thereby improving the efficiency of energy conversion and delivery by the local power source 110. Moreover, critical, everyday devices and appliances are generally continuous loads. Thus, in the case of a power outage, the configuration illustrated in FIG. 1 allows the local power source 110 to provide power to such critical, everyday devices.

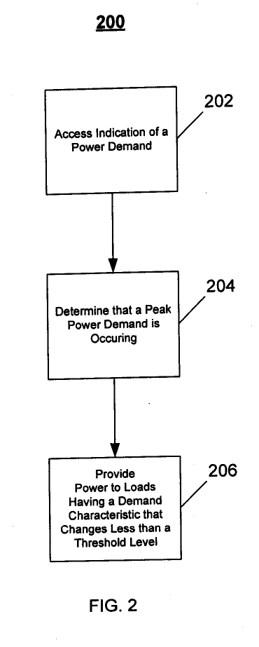

FIG. 2 is a flow chart of an example of a process 200 for reducing peak power demand at location 100 using the configuration illustrated in FIG. 1. The process is initiated by accessing an indication of a power demand at the location 100 (operation 202). A determination that a peak power demand is occurring (or anticipated) at the location is made (operation 204), and, based on the determination that a peak power demand is occurring (or anticipated), power is provided to loads at the location 100 that have a demand characteristic that changes less than a threshold level (operation 206). As suggested by the description accompanying FIG. 1, the loads to which power is provided in operation 206 may be characterized as continuous loads.

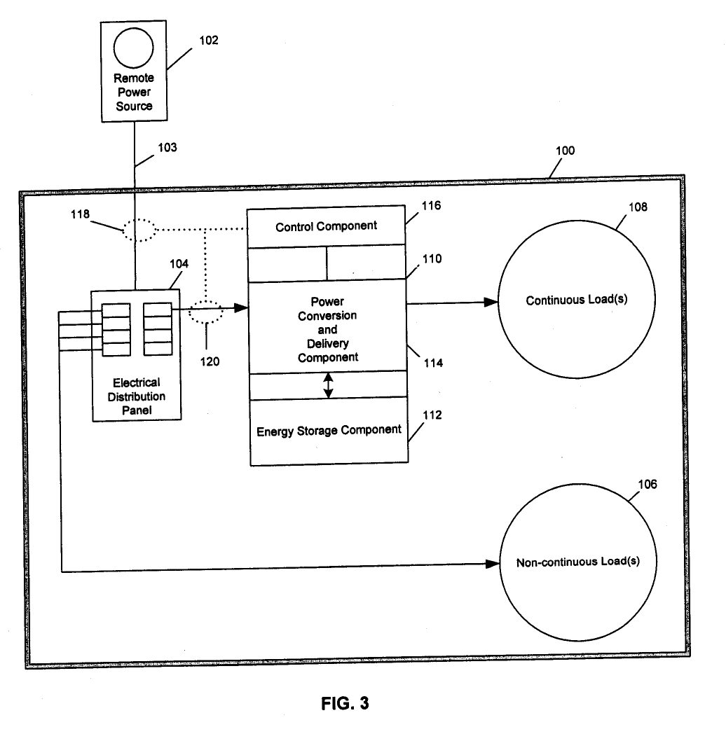

FIG. 3 illustrates the configuration of FIG. 1 with the addition of an illustration of one possible configuration of power sensing devices 118 and 120. Power sensing device 118 is located at the source entry and is connected to the local power source 110. Power sensing device 118 may include one or more current clamps. For example, if the remote power source 102 delivers single-phase power to the location 100, power sensing device 118 may include one current clamp on the wire that provides the single phase power. If the remote power source 102 delivers two-phase power to the location 100, power sensing device 118 may include two current clamps, one for each phase of power delivered. Similarly, if the remote power source 102 delivers three-phase power to the location 100, power sensing device 118 may include three current clamps, one for each phase of power delivered. Power sensing device 118 senses the net power demand at the location 100. In other words, when the local power source 110 is not providing supplemental power, power sensing device 118 senses the overall power demand at the location 100 and when the local power source 110 is providing power, power sensing device 118 senses the difference between the overall power demand at the location 100 and the power provided by the local power source 110, herein referenced as the net power demand.

Power sensing device 120 is located between the electrical distribution panel 104 and the local power source 110 and is connected to the local power source 110. Power sensing device 120 senses the power input to the local power source 110. Power sensing device 120 may include one or more current clamps, one for each phase of power connected to the local power source 110.

The connections between the power sensing devices 118 and 120 and the local power source 110 may be direct (e.g., wired) or indirect (wireless).

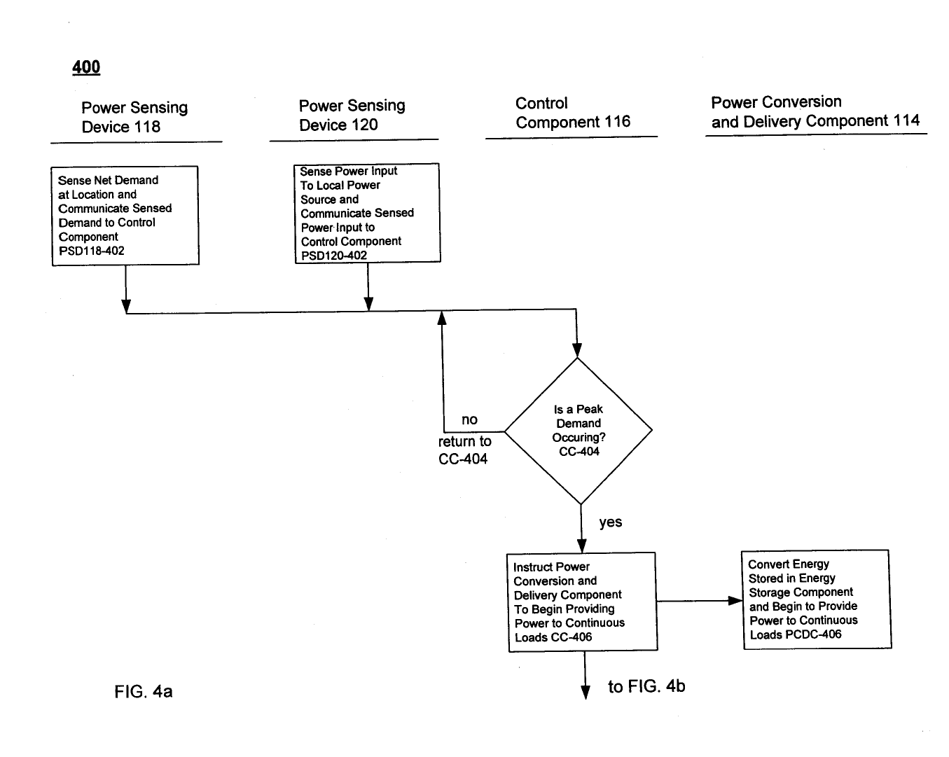

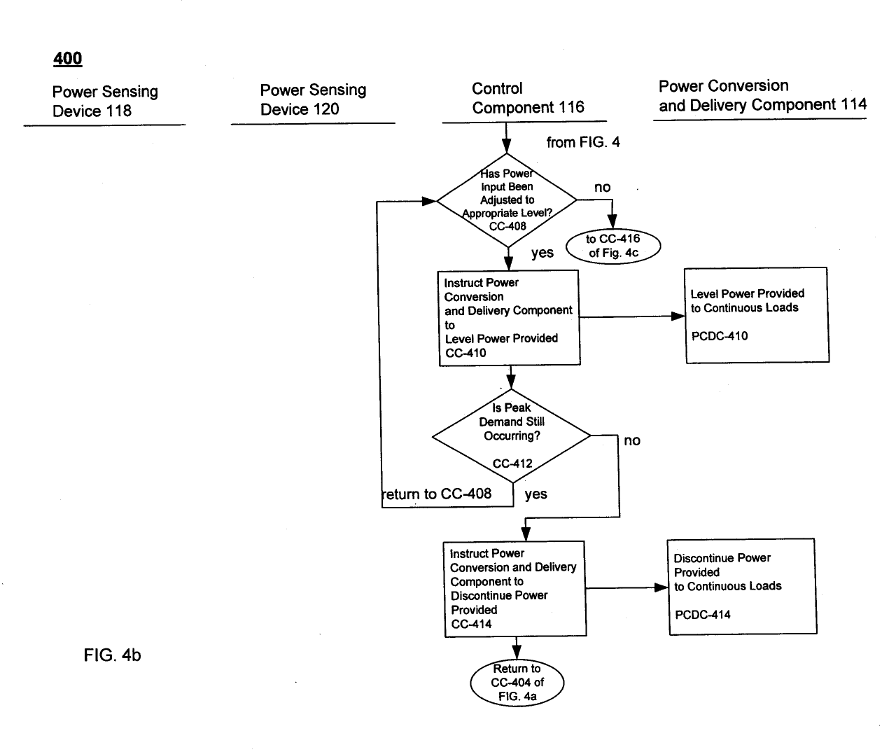

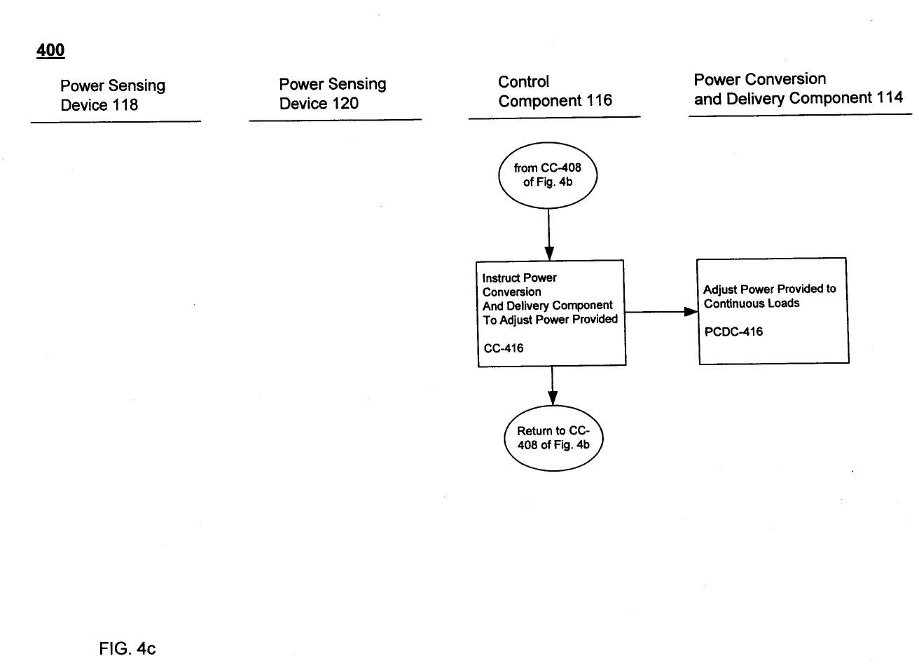

FIGS. 4a-4c are diagrams of a process 400 that relies on power sensing devices 118 and 120 to determine that a peak demand is occurring at the location 100 and to regulate the conversion of energy stored in the energy storage component 112 into power and the delivery of that power to the continuous loads 108 in response to the determination that a peak demand is occurring at the location 100.

Referring to FIG. 4a, power sensing device 118 senses the net power demand at the location 100 and communicates (e.g., continuously, periodically, or upon satisfaction of a predetermined threshold or alert condition) the sensed net demand at the location 100 to the control component 116 (operation PSD118-402). Concurrently, power sensing device 120 senses the power input to the local power source 110 and communicates (e.g., continuously, periodically, or upon satisfaction of a predetermined threshold or alert condition) the sensed power input to the control component 116 (operation PSD120-402).

Based on the sensed net demand at the location 100, the control component 116 determines whether a peak demand is occurring (operation CC-404). For example, the control component 116 of the local power source 110 may determine that a peak demand is occurring if the net demand at the location 100 exceeds a threshold level that represents, for example, average demand (e.g., consumption). In another example, the control component 116 may determine that the net demand at the location 100 exceeds the threshold level by 5 kW. In this example, there is a 5 kW peak in demand (above the threshold level) at the location 100.

The threshold level may be defined explicitly by the party responsible for power at the location 100 or the threshold level may be defined explicitly by the remote power source 102. Additionally or alternatively, the threshold level may be modified dynamically by, for example, the control component 116, based on, for example, one or more of the following factors: historical consumption data (e.g., patterns), the amount of energy stored in the energy storage component 112, the energy storage capacity of the energy storage component 112, and the rate of energy conversion and delivery achievable by the power conversion and delivery component 114. Dynamically modifying the threshold level may be particularly useful when used to enable the system to achieve efficient utilization of the energy stored in the energy storage component.

If the control component 116 determines that a peak demand is not occurring, the process 400 returns to operation CC-404. If the control component 116 determines that a peak demand is occurring, the control component 116 instructs the power conversion and delivery component 114 to begin providing power to the continuous loads 108 (operation CC-406). The power conversion and delivery component 114 converts energy stored in the energy storage component 112 and uses the converted energy to provide power to the continuous loads 108 (operation PCDC-406).

Referring now to FIG. 4b, based on the sensed power input to the local power source 110, the control component 116 determines whether the power input to the local power source 110 has been adjusted to an appropriate level (operation CC-408). For example, if the control component 116 determined that the net demand at the location 100 exceeded the threshold level by 5 kW at operation CC-404, the control component 116 may determine that the power input to the local power source 110 has been adjusted to an appropriate level when the power input has been reduced by 5 kW. Peak reduction is accomplished when the power input to the local power source 110 has been adjusted to an amount substantially equal to the peak in the demand at the location 100 (e.g., the amount by which the demand at the location 100 exceeds the threshold level), because the power delivered to the location 100 by the remote power source 102 has been adjusted by an amount substantially equal to the amount by which the power input to the local power source 110 has been adjusted.

If the power input to the local power source 110 has been adjusted to the appropriate level, the control component 116 instructs the power conversion and delivery component 114 to level off the power provided to the continuous loads 108 (operation CC-410). Accordingly, the power conversion and delivery component 114 levels the power provided to the continuous loads 108 (PCDC-410).

Based on the sensed net demand at the location 100, the control component 116 determines if a peak demand at the location 100 is still occurring (operation CC-412). For example, the control component 116 may determine that a peak demand is no longer occurring after the net demand at the location 100 has fallen below the threshold level by an amount equal to the peak in demand determined at operation CC-404 and the net demand has remained at substantially this same level for a given duration of time. Given the fact that power sensing device 118 senses net demand at the location 100 (i.e., the overall demand minus the power provided by the local power source 110), the control component 116 is configured to determine that a peak power demand is no longer occurring after the net demand has dropped below the threshold level and remained below the threshold level for a given duration of time. When the local power source 110 discontinues providing power, the net demand reflects the overall demand at the location and may be substantially equal to the demand prior to the peak demand. For instance, assuming that the control component 116 determined that the net demand at the location 100 exceeded the threshold level by 5 kW at operation CC-404, the control component 116 may determine that a peak demand is no longer occurring when the net demand has fallen below the threshold level by 5 kW and remained 5 kW below the threshold level for a given duration of time.

If a peak demand is determined to still be occurring (operation CC-412), the process 400 may be configured to return to operation CC-408 to reevaluate whether sufficient supplemental power is being provided to compensate the peak demand and to adjust accordingly. If a peak demand is determined to no longer be occurring (operation CC-412), the control component 116 instructs the power conversion and delivery hardware 114 to discontinue the power provided to the continuous loads 108 (operation CC-414), the power conversion and delivery component 114 discontinues the power provided to the continuous loads 108 (operation PCDC-414), and the process 400 returns to operation CC-404.

Referring now to FIG. 4c, if the power input to the local power source 110 has not been adjusted to the appropriate level, the control component 116 instructs the power conversion and delivery component 114 to adjust the power provided to the continuous loads 108 (operation CC-416), the power conversion and delivery component 114 adjusts the power provided to the continuous loads 108 (operation PCDC-416), and the process returns to operation CC-408. For example, if the power input to the local power source 110 has not been reduced to the appropriate level, the control component 116 instructs the power conversion and delivery component 114 to provide more power to the continuous loads 108. If the power input to the local power source 116 has been reduced below the appropriate level, the control component 116 instructs the power conversion and delivery component 114 to provide less power to the continuous loads 108.

During periods when a peak demand is not occurring, power supplied by the remote power source 102 can be used to recharge the local power source 110. In particular, when the control component 116 determines that a peak demand is not occurring, the control component may instruct the power conversion and delivery component 114 to convert power provided by the remote power source 102 into energy and to store that energy in the energy storage component 112.

Power sensing device 118 may communicate (e.g., continuously, periodically, or upon satisfaction of a predetermined threshold or alert condition) the sensed net demand at the location 100 to the control component 116 allowing the control component 116 to continuously monitor the net demand at the location 100. Similarly, power sensing device 120 may communicate (e.g., continuously, periodically, or upon satisfaction of a predetermined threshold or alert condition) the sensed power input to the local power source 110 to the control component 116. Consequently, the control component 116 may continuously regulate the energy converted into power and provided to the continuous loads 108 by the power conversion and delivery component 114. Thus, the control component 116 may continuously increase and/or decrease the amount of power provided to the continuous loads 108 based on the net demand at the location 100 as sensed by power sensing device 118, thereby achieving dynamic and real-time, or virtually real-time, peak power reduction and load matching without human intervention. Dynamic, virtually real-time control may allow peak demand levels to be reduced adequately without over-utilizing stored energy.

In some implementations, the system depicted in FIG. 3 may be configured without power sensing device 120. In such an implementation, substantially the same process as that illustrated in FIGS. 4a-4c may be performed using information provided by power sensing device 118. For example, instead of using the input power to the local power source 110 sensed by power sensing device 120, the control component 116 can use the net demand sensed by power sensing device 118 to determine whether the local power source 110 is providing sufficient power to continuous loads 108 to reduce the peak demand.

Additionally or alternatively, the system depicted in FIG. 3 may be configured with an additional power sensing device (not shown), located, for example, between the local power source 110 and the continuous loads 108. While the system is capable of determining the amount of power supplied by the local power source 110, this alternative configuration may provide a more precise measure of the power supplied by the local power source 110 because it allows both the power input to the local power source 110 and the overall power provided to the continuous loads 108 to be monitored.

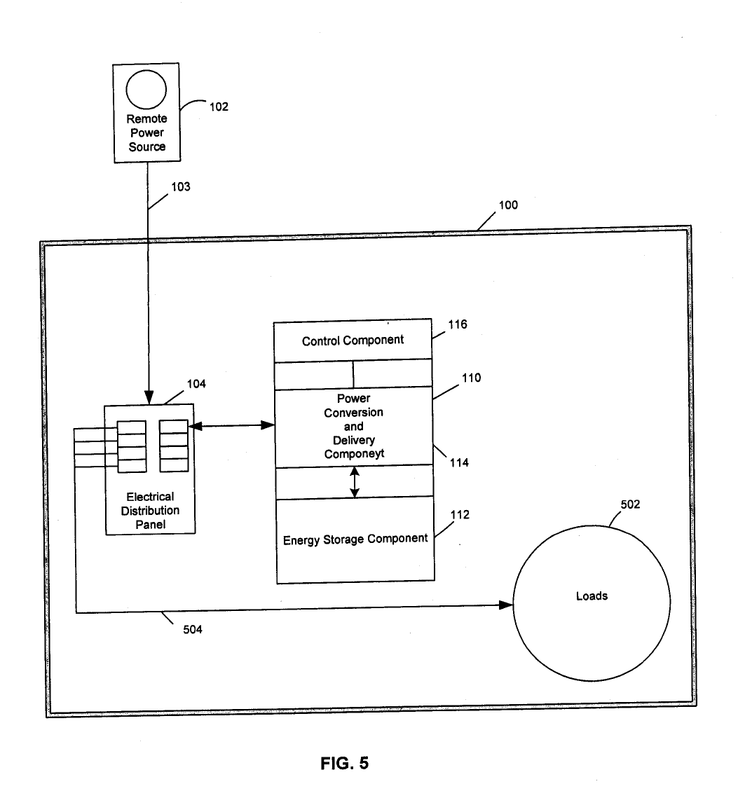

Referring to FIG. 5, the residential location 100 is connected to the remote power source 102 by the electrical transmission system 103. The location 100 demands power from the remote power source 102 and the remote power source 102 delivers power to the residential location 100 to satisfy the demand. The power delivered by the remote power source 102 to the location 100 is received by the electrical distribution panel 104.

Loads 502 are connected to the electrical distribution panel 104 over a local power network 504. The electrical distribution panel 104 receives power from the remote power source 102 and distributes the received power to the loads 502 over the local power network 504. Loads 502 may be continuous loads, non-continuous loads, or a combination of continuous and non-continuous loads.

The local power source 110 is connected to the electrical distribution panel 104 in parallel with the remote power source 102.

When a peak demand occurs at the location 100, local power source 110 provides supplemental power to the loads 502 by injecting power into the local power network 504 through the electrical distribution panel 104. For example, when the power demand at the location 100 exceeds a threshold level, the local power source 110 may inject a quantum of power into the local power network 504 that is equal to, or substantially equal to, the amount by which the power demand at the location 100 exceeds the threshold level. As a result, the net power demanded by the location 100—and thus the net power delivered by the remote power source 102—is reduced by the quantum of power injected into the local power network 504.

The power provided to the loads 502 by the local power source 110 during a peak demand is supplemental power. That is, during a period of peak demand, the power provided to the loads 502 includes power received from the remote power source 102 as well as power provided by the local power source 110. The control component 116 monitors the power provided by the local power source 110 to prevent the local power source 110 from providing more power than the overall power demand at the location 100, thereby preventing the local power source 110 from sending power back to the remote power source 102.

During periods of time when limited or no power is delivered to the location 100 by the remote power source 102 (e.g., a power outage, a brownout, or a blackout), the local power source 100 also can be used to provide power to the loads 502.

The configuration of the location 100 illustrated in FIG. 5, whereby the local power source 110 is arranged in parallel with the remote power source 102 and configured to provide supplemental power to the loads 502 has particular utility, for example, during a peak demand since the local power source 110 is never without a load to power. Furthermore, detailed knowledge of specific loads generally is not required when the local power source 110 is deployed as illustrated in FIG. 5.

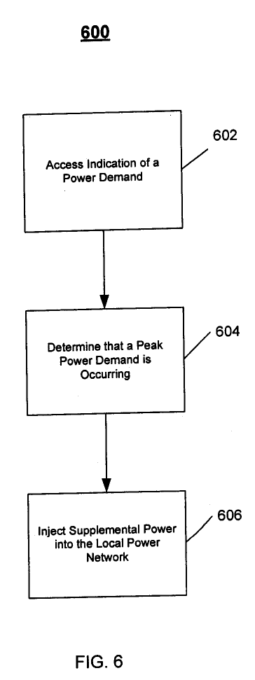

FIG. 6 is a flow chart of an exemplary process 600 for reducing peak power demand at location 100 using, for instance, the configuration illustrated in FIG. 5. The process is initiated by accessing an indication of a power demand at the location 100 (operation 602). A determination that a peak power demand is occurring (or anticipated) at the location is made (operation 604), and, based on the determination that a peak power demand is occurring (or anticipated), supplemental power is provided to the loads 502 at the location 100 by injecting supplemental power into the local power network 504 (operation 606).

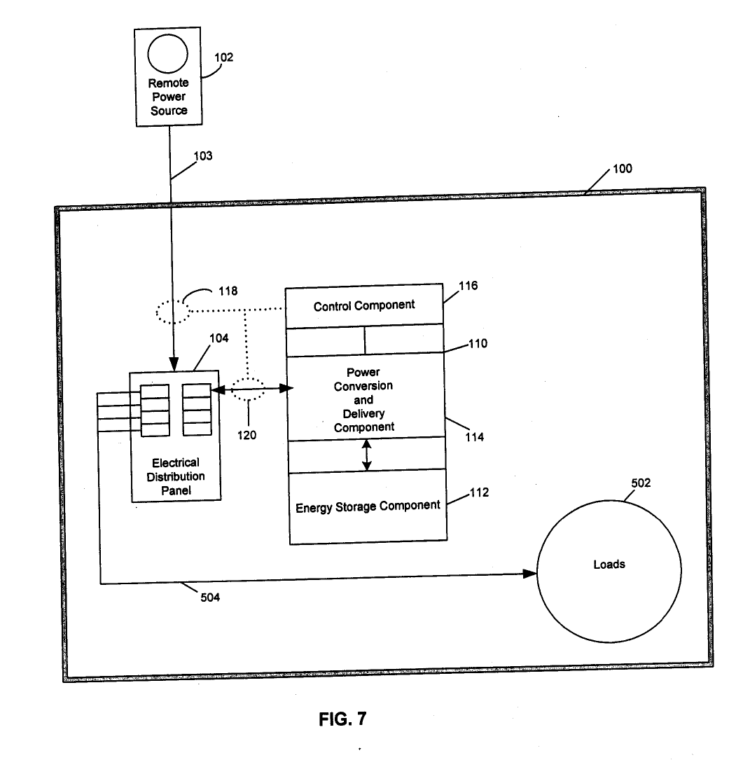

FIG. 7 illustrates the configuration of FIG. 5 with the addition of an illustration of one possible configuration of power sensing devices 118 and 120. Power sensing device 118 is located at the source entry and is connected to the local power source 110. Power sensing device 118 senses the net power demand at the location 100.

Power sensing device 120 is located between the electrical distribution panel 104 and the local power source 110 and is connected to the local power source 110. Power sensing device 120 senses the power output by the local power source 110.

The connections between the power sensing devices 118 and 120 and the local power source 110 may be direct (e.g., wired) or indirect (wireless).

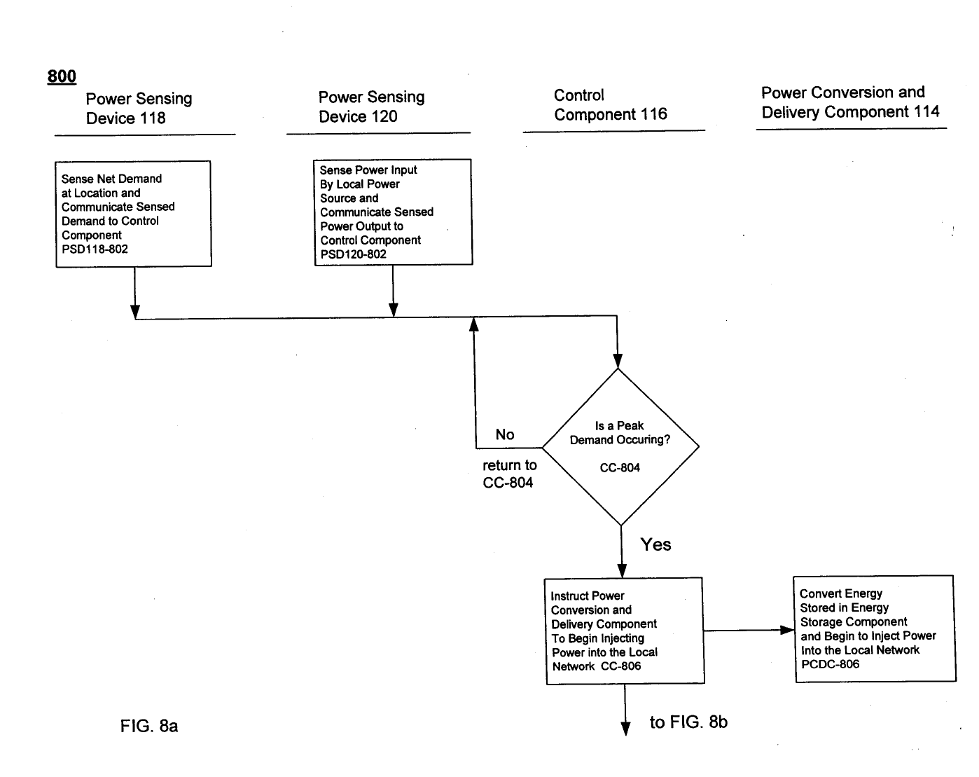

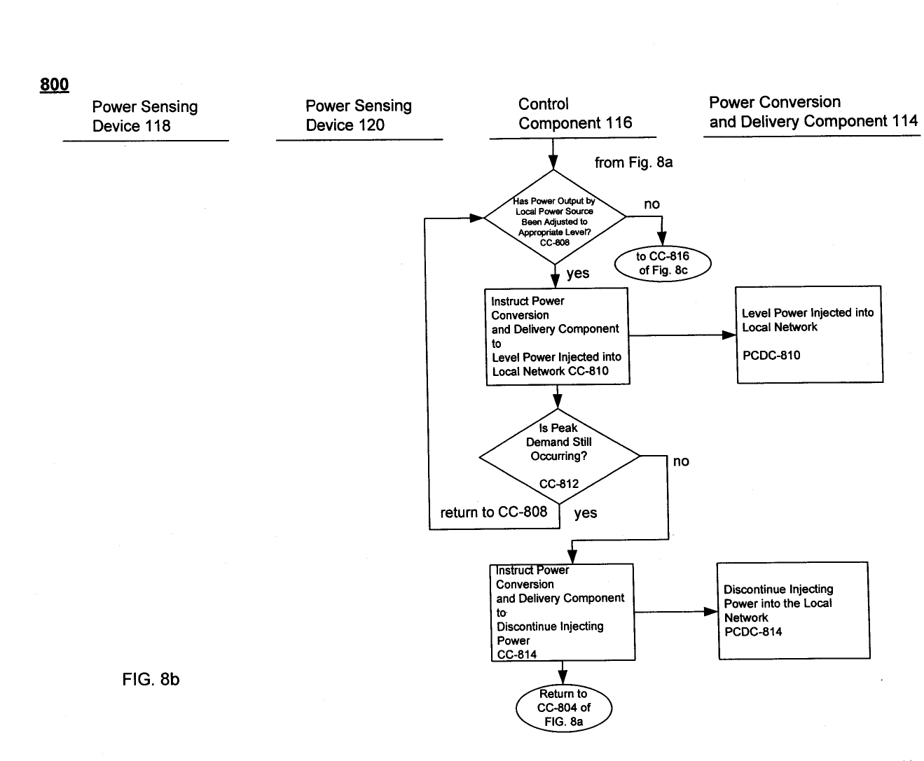

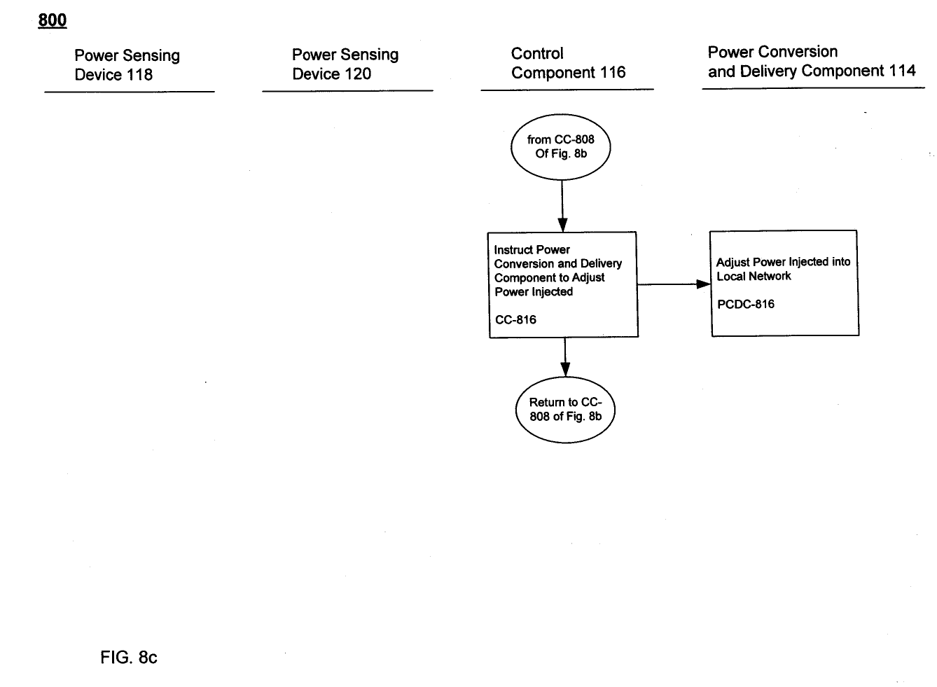

FIGS. 8a-8c are diagrams of a process 800 that relies on the power sensing devices 118 and 120 to determine that a peak demand is occurring at the location 100 and to regulate the conversion of energy stored in the energy storage component 112 into power and the injection of that power into the local power network 504 in response to the determination that a peak demand is occurring at the location 100.

Referring to FIG. 8a, power sensing device 118 senses the net power demand at the location 100 and communicates (e.g., continuously, periodically, or upon satisfaction of a predetermined threshold or alert conditions) the sensed net demand at the location 100 to the control component 116 (operation PSD118-802). Concurrently, power sensing device 120 senses the power output by the local power source 110 and (e.g., continuously, periodically, or upon satisfaction of a predetermined threshold or alert conditions) communicates the sensed power input to the control component 116 (operation PSD120-802).

Based on the sensed net demand at the location 100, the control component 116 determines whether a peak demand is occurring (operation CC-804). For example, the control component 116 of the local power source 110 may determine that a peak demand is occurring if the net demand at the location 100 exceeds a threshold level that represents, for example, average demand (e.g., consumption). In another example, the control component 116 may determine that the net demand at the location 100 exceeds the threshold level by a threshold amount, e.g., by 5 kW. In this example, there is a 5 kW peak in demand (above the threshold level) at the location 100. As discussed in connection with FIG. 4a, the threshold level may be defined explicitly, or, additionally or alternatively, the threshold level may be dynamically modified by, for example, the control component 116.

If the control component 116 determines that a peak demand is not occurring, the process 800 returns to operation CC-804. If the control component 116 determines that a peak demand is occurring, the control component 116 instructs the power conversion and delivery component 114 to begin injecting power into the local network 504 (operation CC-806). The power conversion and delivery component 114 converts energy stored in the energy storage component 112 and uses the converted energy to inject power into the local network 504 (operation PCDC-806). Injecting power into the local power network 504 may require the local power source 110 to synchronize AC waveforms and frequencies with the waveforms and frequencies of the power delivered by the remote power source 102. Injecting power into the local power network 504 may also require the local power source 110 to rely on real-time or virtually real-time measurements to control the power conversion and delivery component so as to inject stored energy into the local power network 504 at a variable rate.

Referring now to FIG. 8b, based on the sensed power output by the local power source 110, the control component 116 determines whether the power output by the local power source 110 has been adjusted to an appropriate level (operation CC-808). For example, if the control component 116 determined that the net demand at the location 100 exceeded the threshold level by 5 kW at operation CC-804, the control component 116 may determine that the power output by the local power source 110 has been adjusted to an appropriate level when the power output has increased by slightly less than 5 kW. Control component 116 insures that the power output by the local power source 110 is always less than the total demand at the location 100. Consequently, power is not sent back to the remote power source 102 from the location 100. Peak reduction is accomplished when the power output by the local power source 110 has been adjusted to an amount slightly less than the peak in demand at the location 100 (e.g., the amount by which the demand at the location 100 exceeds the threshold level), because the power delivered to the location 100 by the remote power source 102 has been adjusted by an amount substantially equal to the amount by which the power output by the local power source 110 has been adjusted.

If the power output by the local power source 110 has been adjusted to the appropriate level, the control component 116 instructs the power conversion and delivery component 114 to level off the power injected into the local network 504 (operation CC-810). Accordingly, the power conversion and delivery component 114 levels the power injected into the local network 504 (PCDC-810).

Based on the sensed net demand at the location 100, the control component 116 determines if a peak demand at the location 100 is still occurring (operation CC-812). For example, the control component 116 may determine that a peak demand is no longer occurring after the net demand at the location 100 has fallen below the threshold level by an amount equal to the peak in demand determined at operation CC-804 and the net demand has remained at substantially this same level for a given duration of time. Due to the fact that power sensing device 118 senses net demand at the location 100 (i.e., the difference between the overall demand and the power provided by the local power source 110), the control component 116 is configured to determine that a peak power demand is no longer occurring after the net demand has dropped below the threshold level and remained below the threshold level for a given duration of time. When the local power source 110 discontinues injecting power, the net demand reflects the overall demand at the location and may be substantially equal to the demand prior to the peak demand. For instance, assuming that the control component 116 determined that the net demand at the location 100 exceeded the threshold level by 5 kW at operation CC-404, the control component 116 may determine that a peak demand is no longer occurring if the net demand has fallen below the threshold level by 5 kW and remained 5 kW below the threshold level for a given duration of time. For instance, if the control component 116 determined that the net demand at the location 100 exceeded the threshold level by 5 kW at operation CC-804, the control component 116 may determine that a peak demand is no longer occurring if the net demand has fallen below the threshold level by 5 kW and remained 5 kW below the threshold level for a given duration of time.

If a peak demand is determined to still be occurring (operation CC-802), the process 800 may be configured to return to operation CC-808 to reevaluate whether sufficient supplemental power is being provided to compensate the peak demand and to adjust accordingly. If a peak demand is determined to no longer be occurring (operation CC-812), the control component 116 instructs the power conversion and delivery hardware 114 to discontinue injecting power into the local network 504 (operation CC-814), the power conversion and delivery component 114 discontinues injecting power into the local network 504 (operation PCDC-814), and the process 800 returns to operation CC-804.

Referring now to FIG. 8c, if the power output by the local power source 110 has not been adjusted to the appropriate level, the control component 116 instructs the power conversion and delivery component 114 to adjust the power injected into the local power network 504 (operation CC-816), the power conversion and delivery component 114 adjusts the power injected into the local power network 504 (Operation PCDC-816), and the process returns to operation CC-808. For example, if the power output by the local power source 110 has not been increased to the appropriate level, the control component 116 instructs the power conversion and delivery component 114 to inject more power into the local power network 504. If the power output by the local power source 110 has been increased above the appropriate level, the control component 116 instructs the power conversion and delivery component 114 to inject less power into the local power network 504.

Power sensing device 118 may communicate (e.g., continuously, periodically, or upon satisfaction of a predetermined threshold or alert condition) the sensed net demand at the location 100 to the control component 116 allowing the control component 116 to continuously monitor the net demand at the location 100. Similarly, power sensing device 120 may communicate (e.g., continuously, periodically, or upon satisfaction of a predetermined threshold or alert condition) the sensed power output by the local power source 110 to the control component 116. Consequently, the control component 116 may continuously regulate the energy converted into power and injected into the local power network 504 by the power conversion and delivery component 114. Thus, the control component 116 may continuously increase and/or decrease the amount of power injected into the local power network 504 based on the net demand at the location 100 as sensed by power sensing device 118, thereby achieving dynamic and real-time, or virtually real-time, peak power reduction and load matching without human intervention.

In some implementations, the system depicted in FIG. 7 may be configured with only power sensing device 120. In such an implementation, substantially the same process as that illustrated in FIGS. 8a-8c may be performed using information provided by power sensing device 118. For example, instead of using the power output by the local power source 110 sensed by power sensing device 120, the control component 116 can use the net demand sensed by power sensing device 118 to determine whether the local power source 110 is injecting sufficient power into the local power network 504 to reduce the peak demand.

Additionally or alternatively, the system depicted in FIG. 7 may be configured with an additional power sensing device (not shown), located, for example, between the electrical distribution panel 104 and the loads 502. While the system is capable of determining the amount of power injected into the local power network 504 by the local power source 110, the alternative configuration may provide a more precise measure of the power supplied by the local power source 110 because it allows both the power injected into the local network 504 by the local power source 110 and the overall power provided to the loads 502 to be monitored.

As discussed above, the control component 116 causes the local power source 110 to provide power in response to sensing a peak demand at the location 100. However, in one implementation, the control component 116 may communicate with additional entities and the control component 116 may cause the local power source 110 to provide power in response to other stimuli or operational parameters in addition to, or in place of, peak power demand at the location 100. These parameters may include, for example, historical power and energy consumption data, environmental parameters such as temperature, utility responses and operational parameters, utility crisis situation dispatches, look-up tables based on analytical data relating to peak demand issues, energy storage levels and the operational health of the local power source 110, time of day and seasonal timing parameters, load profile data from main electrical service entries, and load profile data of individual loads contributing to peak demands.

For example, the control component 116 may recognize that the location 100 incurs a peak demand most mornings from 7:00-7:15 am. This peak demand may be attributable, for example, to the fact that the owner of the location 100 uses an espresso machine most mornings between 7:00-7:15 am to prepare a cup of espresso. Recognition of the fact that the location 100 incurs a peak demand between 7:00-7:15 am most mornings may allow the local power source 110 to begin providing supplemental power even before a peak demand is sensed, thereby allowing the local power source 110 to further reduce the peak demand at the location 100.

The ability of the control component 116 to communicate with other entities and to respond to other stimuli in addition to, or in place of, a determination of peak power demand at the location 100 may also benefit the remote power source 102, especially when a network of distributed energy storage devices are deployed at numerous locations served by the remote power source 102.

For example, in the event of a utility crisis or transmission system failure, the remote power source 102 may send a mass dispatch to the network of distributed energy storage devices instructing the individual energy storage devices to provide power to loads resident at their locations. Such an emergency response may benefit the system as a whole by limiting the amount of power that must be carried over the transmission system, which may be the weakest link in the overall system.

Similarly, the remote power source 102 may monitor historical power demand for the locations it serve. As a result, the remote power source 102 may recognize, for example, that it experiences a peak power demand during afternoons in August. This peak power demand may be attributable, for example, to the widespread use of air conditioning units at locations served by the remote power source 102 during August afternoons. In anticipation of a peak power demand on an August afternoon, the remote power source 102 may send a mass dispatch to the network of distributed energy storage devices instructing the individual energy storage devices to provide power to loads resident at their locations. Such a prophylactic, anticipatory measure may benefit the system as a whole by reducing the amount of power the remote power source 102 is required to generate while simultaneously reducing the amount of power that must be carried over the transmission system.

A number of implementations have been described. Nevertheless, it will be understood that various modifications may be made. For example, a compact disk (CD), a processing device, or other computer readable medium may contain a program, instructions, or code segments for implementing any of the methods disclosed. In addition, a tool may be provided for implementing any of the methods disclosed. The tool may include, for example, a computer-readable medium, a processing device, an energy storage device, or a combination of these and possibly other components. A processing device may include, for example, a processor, a computer, a programmable logic device, or an integrated circuit.

In addition, while the systems and methods disclosed generally have been described in the context of power demand at a residential location, the systems and methods disclosed may be equally applicable in the context of non-residential locations (e.g., commercial locations) as well.

While the methods described were described as including multiple operations, additional operations may be added to the methods disclosed. Furthermore, it may not be necessary to perform each operation described, and, therefore, some operations may be skipped. Moreover, the disclosed operations do not necessarily have to be performed in the order in which they were described.

Finally, various technologies may be used, combined, and modified to produce an implementation, such technologies including, for example, a variety of hardware, software, firmware, integrated components, discrete components, processing devices, memory or storage devices, communication devices, batteries, flywheels, fuel cells, combustible fuels, DC-AC inverters, and generators.

Accordingly, other implementations are within the scope of the following claims.

What is claimed is:

1. A system configured for operation at a residential location that has at least one load that exhibits a demand characteristic that changes in excess of a threshold level, at least one load that has a demand characteristic that changes less than the threshold level, and an electrical distribution panel that is configured to receive power at the residential location from a remote power source, to distribute a portion of the received power to the at least one load that has a demand characteristic that changes in excess of the threshold level, and to distribute another portion of the received power to the at least one load that has a demand characteristic that changes less than the threshold level, the system comprising:
a local power source configured to:
connect to the electrical distribution panel,
connect, in series, to the at least one load that has a demand characteristic that changes less than the threshold level,
access an indication of a power demand generated by loads at the residential location,
determine, based on the accessed indication of power demand generated by loads at the residential location, that a peak power demand is occurring at the residential location, and
based on the determination that the peak power demand is occurring at the residential location, provide power to the at least one load that has a demand characteristic that changes less than the threshold level.

2. The system of claim 1 wherein the local power source includes:
a component for storing energy;
a component for converting the stored energy and providing power; and
a processing device configured to:
access the indication of the power demand generated by loads at the residential location,
determine, based on the accessed indication of power demand generated by loads at the residential location, that the peak power demand is occurring at the residential location, and
inspire the component for converting the stored energy and providing power to provide power to the at least one load that has a demand characteristic that changes less than the threshold level, based on the determination that the peak power demand is occurring at the residential location.

3. The system of claim 2 further comprising a location demand sensing device configured to:
sense the power demand at the residential location; and
provide the indication of the power demand at the residential location.

4. The system of claim 3 wherein the location demand sensing device is located at the electrical distribution panel.

5. The system of claim 4 wherein:
the received power includes a received current; and
the location demand sensing device includes a current clamp that senses the received current.

6. The system of claim 4 further comprising an input power sensing device configured to:
sense a power input to the local power source; and
provide an indication of the power input to the local power source;
wherein the processing device is further configured to:
access the indication of the power input to the local power source; and
regulate the power provided by the component for converting the stored energy and providing power to the at least one load that-has a demand characteristic that changes less than the threshold level.

7. The system of claim 6 wherein:
the power input to the local power source includes an input current; and
the input power sensing device includes a current clamp that senses the input current.

8. The system of claim 1 wherein the local power source determines that the peak power demand is occurring at the residential location based, at least in part, on the indication of the power demand at the residential location.

9. The system of claim 8 wherein:
the local power source is further configured to access one or more operational parameters; and to determine that the peak power demand is occurring at the residential location based on the one or more operational parameters in addition to the indication of the power demand at the residential location.

10. The system of claim 9 wherein the one or more operational parameters include:
historical power and energy consumption data;
environmental data;
utility response data;
utility crisis situation dispatch data;
look-up tables based on analytical data relating to peak demand issues;
local power source energy storage level data;
local power source operational health data;
time of day data;
seasonal timing data;
load profile data from main electrical service entries; and
load profile data of individual loads.

11. The system of claim 1 wherein the local power source is further configured to provide power supplemental to and concurrently with the portion of the received power distributed to the at least one load that has a demand characteristic that changes less than the threshold level.

12. A method comprising:
providing a tool configured for:
accessing an indication of a power demand generated by loads at a residential location that has at least one load that has a demand characteristic that changes in excess of a threshold level, at least one load that has a demand characteristic that changes less than the threshold level, and an electrical distribution panel configured to receive power at the residential location from a remote source, distribute a portion of the received power to the at least one load that has a demand characteristic that changes in excess of the threshold level, and to distribute a portion of the received power to the at least one load that has a demand characteristic that changes less than the threshold level;
determining, based on the accessed indication of power demand generated by loads at the residential location, that a peak power demand is occurring at the residential location; and
based on the determination that the peak power demand is occurring at the residential location, providing power to the at least one load that has a demand characteristic that changes less than the threshold level.

13. The method of claim 12 wherein:
the received power includes a received current; and
accessing an indication of the power demand at the residential location includes sensing the received current at the electrical distribution panel.

14. The method of claim 13 further comprising:
sensing a power input to the local power source, and
wherein providing power to the at least one load that has a demand characteristic that changes less than the threshold level includes controlling the power provided based on the sensed power input to the local power source.

15. The method of claim 12 wherein the determination that the peak power demand is occurring at the residential location is based, at least in part, on the indication of the power demand at the residential location.

16. The method of claim 15 wherein:
the tool is further configured for accessing one or more operational parameters; and
the determination that the peak power demand is occurring at the residential location is based on the one or more operational parameters in addition to the indication of the power demand at the residential location.

17. The method of claim 16 wherein the one or more operational parameters include:
historical power and energy consumption data;
environmental data;
utility response data;
utility crisis situation dispatch data;
look-up tables based on analytical data relating to peak demand issues;
local power source energy storage level data;
local power source operational health data;
time of day data;
seasonal timing data;
load profile data from main electrical service entries; and
load profile data of individual loads.

18. The method of claim 12 wherein:
determining that a peak power demand is occurring includes determining an amount by which the power demand at the residential location exceeds a desired level, and
providing power to the at least one load that has a demand characteristic that changes less than the threshold level includes providing no more power than the amount by which the power demand at the residential location exceeds the desired level.

19. The method of claim 12 wherein providing power to the at least one load that has a demand characteristic that changes less than the threshold level includes providing power supplemental to and concurrently with the portion of the received power distributed to the at least one load that has a demand characteristic that changes less than the threshold level.

20. A system configured for operation at a location that has an electrical distribution panel, one or more loads, and a local power network connected to the electrical distribution panel and the one or more loads, the electrical distribution panel configured to receive power at the location from a remote power source and distribute the received power to the one or more loads over the local power network, the system comprising:
a local power source, at the location, configured to:
connect to the electrical distribution panel in parallel with the remote power source,
access an indication of a power demand generated by loads at the location,
determine, based on the accessed indication of power demand generated by loads at the location, that a peak power demand is occurring at the location, and
based on the determination that the peak power demand is occurring at the location, inject supplemental power through the electrical distribution panel into the local power network, such that the supplemental power and the received power are distributed to the one or more loads concurrently.

21. The system of claim 20 wherein the local power source is further configured to limit the supplemental power injected into the local power network such that the supplemental power is less than the indication of the power demand at the location.

22. The system of claim 20 wherein the local power source includes:
a component for storing energy;
a component for converting the stored energy and providing power; and
a processing device configured to:
access the indication of the power demand at the location,
determine, based on the accessed indication of power demand at the location, that the peak power demand is occurring at the location, and
inspire the component for converting the stored energy and providing power to inject supplemental power through the electrical distribution panel into the local power network, based on the determination that the peak power demand is occurring at the location.

23. The system of claim 22 further comprising a location demand sensing device configured to:
sense the power demand at the location; and
provide the indication of the power demand at the location.

24. The system of claim 23 wherein the location demand sensing device is located at the electrical distribution panel.

25. The system of claim 24 wherein:
the received power includes a received current; and
the location demand sensing device includes a current clamp that senses the received current.

26. The system of claim 25 further comprising an output power sensing device configured to:
sense a power output by the local power source; and
provide an indication of the power output by the local power source;
wherein the processing device is further configured to:
access the indication of the power output by the local power source; and
regulate the power injected into the local power network by the component for converting the stored energy and providing power.

27. The system of claim 26 wherein:
the power output by the local power source includes an output current; and
the output power sensing device includes a current clamp that senses the output current.

28. The system of claim 20 wherein the local power source determines that the peak power demand is occurring at the location, and the determination that the peak power demand is occurring at the location is based, at least in part, on the indication of the power demand at the location.

29. The system of claim 28 wherein:
the local power source is further configured to access one or more operational parameters; and
the determination that the peak power demand is occurring at the location is based on the one or more operational parameters in addition to the indication of the power demand at the location.

30. The system of claim 29 wherein the one or more operational parameters include:
historical power and energy consumption data;
environmental data;
utility response data;
utility crisis situation dispatch data;
look-up tables based on analytical data relating to peak demand issues;
local power source energy storage level data;
local power source operational health data;
time of day data;
seasonal timing data;
load profile data from main electrical service entries; and
load profile data of individual loads.

31. A method comprising:
providing a tool configured for
accessing an indication of a power demand at a location that has an electrical distribution panel, one or more loads, and a local power network connected to the electrical distribution panel and the one or more loads, the electrical distribution panel configured to receive power at the location from a remote power source and distribute the received power to the one or more loads over the local power network;
determining, based on the accessed indication of power demand at the location, that a peak power demand is occurring at the location; and
based on the determination that the peak power demand is occurring at the location, injecting supplemental power through the electrical distribution panel into the local power network, such that the supplemental power and the received power are distributed to the one or more loads concurrently.

32. The method of claim 31 wherein:
the received power includes a received current; and
accessing an indication of the power demand at the location includes sensing the received current at the electrical distribution panel.

33. The method of claim 32 further comprising:
sensing a power output by the local power source;
wherein injecting power into the local power network includes controlling the power injected based on the sensed power output by the local power source.

34. The method of claim 31 wherein the determination that the peak power demand is occurring at the location is based, at least in part, on the indication of the power demand at the location.

35. The method of 34 wherein:
the tool is further configured for accessing one or more operational parameters; and
the determination that the peak power demand is occurring at the location is based on the one or more operational parameters in addition to the indication of the power demand at the location.

36. The method of claim 35 wherein the one or more operational parameters include:
historical power and energy consumption data;
environmental data;
utility response data;
utility crisis situation dispatch data;
look-up tables based on analytical data relating to peak demand issues;
local power source energy storage level data;
local power source operational health data;
time of day data;
seasonal timing data;
load profile data from main electrical service entries; and
load profile data of individual loads.

37. A method comprising:
providing a tool for:
accessing an indication of a power demand at a residential location,
accessing one or more operational parameters,
determining, based on the accessed indication of the power demand at the residential location and the accessed one or more operational parameters, that a peak power demand is occurring at the residential location.

38. The method of claim 37 wherein the one or more operational parameters include:
historical power and energy consumption data;
environmental data;
utility response data;
utility crisis situation dispatch data;
look-up tables based on analytical data relating to peak demand issues;
local power source energy storage level data;
local power source operational health data;
time of day data;
seasonal timing data;
load profile data from main electrical service entries; and
load profile data of individual loads.
